(19) United States
(12) Patent Application Publication
(10) Pub. No.: US 2013/0001067 A1
(43) Pub. Date: Jan. 3, 2013

(54) METHOD AND SYSTEM FOR SPLITTING WATER WITH VISIBLE LIGHT

(75) Inventor: David A. Boyd, La Canada Flintridge, CA (US)

(73) Assignee: California Institute of Technology, Pasadena, CA (US)

(21) Appl. No.: 13/335,878

(22) Filed: Dec. 22, 2011

Related U.S. Application Data
(60) Provisional application No. 61/426,721, filed on Dec. 23, 2010.

(51) Int. Cl. B01J 19/12; C01B 3/02; B82Y 99/00

(52) U.S. Cl. 204/157.41; 204/157.52; 422/186; 977/902; 977/773

(57) ABSTRACT

A method of producing hydrogen includes providing a substrate having a plurality of nanoparticles disposed thereon and providing a source of electromagnetic radiation. The method also includes immersing the plurality of nanoparticles in an aqueous solution and irradiating at least a portion of the substrate having the plurality of nanoparticles disposed thereon with electromagnetic radiation. The method further includes exciting a plasmon resonance in the plurality of nanoparticles and converting a portion of the aqueous solution to hydrogen.

### CROSS-REFERENCES TO RELATED APPLICATIONS

This application claims priority to U.S. Provisional Patent Application No. 61/426,721, filed on Dec. 23, 2010, the disclosure of which is hereby incorporated by reference in its entirety.

### STATEMENT AS TO RIGHTS TO INVENTIONS MADE UNDER FEDERALLY SPONSORED RESEARCH OR DEVELOPMENT

This invention was made with government support under FA9550-10-C-0073 awarded by the Air Force. The government has certain rights in the invention.

### BACKGROUND OF THE INVENTION

Hydrogen is of great industrial importance and has potential as an advanced fuel. Water provides a direct source for hydrogen. A traditional route for producing hydrogen is electrolysis of water. However, this process is energy intensive. Visible light photocatalysis, that is splitting of water with visible light, has been the subject of research.

A conventional approach to photocatalysis of water involves semiconductors. Light of sufficient energy, i.e. above the bandgap of the material, creates electron-hole pairs. The excited electron reduces water to form hydrogen and the holes oxidize water to form oxygen. There are a number of problems with this approach. The first issue relates to the bandgap of the host material. The bandgap of the materials must be of sufficient energy and the conduction and valence bands must be properly situated. The second issue relates to material stability.

Typically, the material must be able to withstand a harsh chemical solution for long period of time. There are limited if any materials that can meet both demands. For example, titanium oxide is able to withstand extreme solutions, but the bandgap is energy is accessible only with ultraviolet, not visible light.

### SUMMARY OF THE INVENTION

The present invention relates generally to methods and systems for photocatalysis of water. More particularly, embodiments of the present invention relate to the use of optical excitations in metal nanoparticles supported by a reducible metal oxide to perform photocatalysis of water. The methods and techniques can be applied to a variety of materials, applications, and fields.

According to an embodiment of the present invention, a method of producing hydrogen is provided. The method includes providing a substrate having a plurality of nanoparticles disposed thereon and providing a source of electromagnetic radiation. The method also includes immersing the plurality of nanoparticles in an aqueous solution and irradiating at least a portion of the substrate having the plurality of nanoparticles disposed thereon with electromagnetic radiation. The method further includes exciting a plasmon resonance in the plurality of nanoparticles and converting a portion of the aqueous solution to hydrogen.

According to another embodiment of the present invention, an alternate method of producing hydrogen is provided. The method includes providing a metal oxide material and a plurality of metal nanoparticles and providing a source of electromagnetic radiation. The method also includes expose the metal oxide material and the plurality of metal nanoparticles to a source of hydrogen and irradiating at least a portion of the metal oxide material and the plurality of metal nanoparticles with the electromagnetic radiation. The method further includes exciting a plasmon resonance in the plurality of metal nanoparticles and producing hydrogen from the source of hydrogen.

According to a specific embodiment of the present invention, a structure for use in hydrogen production is provided. The structure includes a substrate having a plurality of nanoparticles disposed thereon and an aqueous solution in fluid communication with the substrate. The structure also includes a source of electromagnetic radiation and an optical system directing the electromagnetic radiation to impinge on the substrate. The structure further includes a plasmon absorption region of the substrate operable to absorb electrons from the solution and a reaction region of the substrate operable to produce hydrogen.

Numerous benefits are achieved by way of the present invention over conventional techniques. For example, embodiments of the present invention provide techniques for splitting water in which the photocatalysis reaction is not directly affected by the bandgap of the material. Additionally, embodiments of the present invention perform photocatalysis without requiring extreme temperatures. Moreover, robust materials are utilized in some embodiments of the present invention, providing long system life and reliability. These and other embodiments of the invention, along with many of its advantages and features, are described in more detail in conjunction with the text below and attached figures.

### BRIEF DESCRIPTION OF THE DRAWINGS

FIG. 1 is simplified schematic diagram illustrating a system for photocatalysis of water according to an embodiment of the present invention;

FIG. 2 is a simplified schematic diagram illustrating a photocatalysis process according to an embodiment of the present invention.

FIG. 3 is a simplified schematic diagram illustrating a microchannel operable to support photocatalysis of water according to an embodiment of the present invention;

FIGS. 4A-4C are images of a hydrogen bubble formation in the microchannel illustrated in FIG. 3 according to an embodiment of the present invention;

FIG. 5 is a simplified flowchart illustrating a method of producing hydrogen according to an embodiment of the present invention;

FIG. 6 is a simplified flowchart illustrating a method of performing photocatalysis according to an embodiment of the present invention; and

FIG. 7 is a simplified schematic diagram of a system for producing hydrogen according to an embodiment of the present invention.

### DETAILED DESCRIPTION OF SPECIFIC EMBODIMENTS

Embodiments of the present invention relate to methods and systems for photocatalysis of water. More particularly, embodiments of the present invention relate to the use of optical excitations in metal nanoparticles coupled to a reducible metal oxide to perform photocatalysis of water. The methods and techniques can be applied to a variety of materials, applications, and fields.

Embodiments of the present invention utilize plasmon-induced photoelectrochemistry catalysis to provide a low cost artificial photosynthesis system that can generate hydrogen fuel directly from water, while using visible light and a low cost (i.e., earth abundant) catalyst that does not substantially degrade. As an example, plasmon mediated photosynthesis is used to generate hydrogen from water. As described below, a gold nanoparticle/ceria (Au/CeO₂) catalyst is exposed to visible light in a process to generate hydrogen from water. In some implementations, the efficiency of hydrogen production increases with light flux. Without limiting embodiments of the present invention, the inventor believes that plasmon assisted heating and charge transfer occurs in the immediate vicinity of Au and CeO₂, which releases oxygen and creates an oxygen vacancy, thereby generating hydrogen. Since the charge transfer is mediated by plasmon physics, device lifetime is greater than in conventional approaches. Low cost self assembly methods can be used to accomplish the deposition of the gold nanoparticles on the ceria substrate.

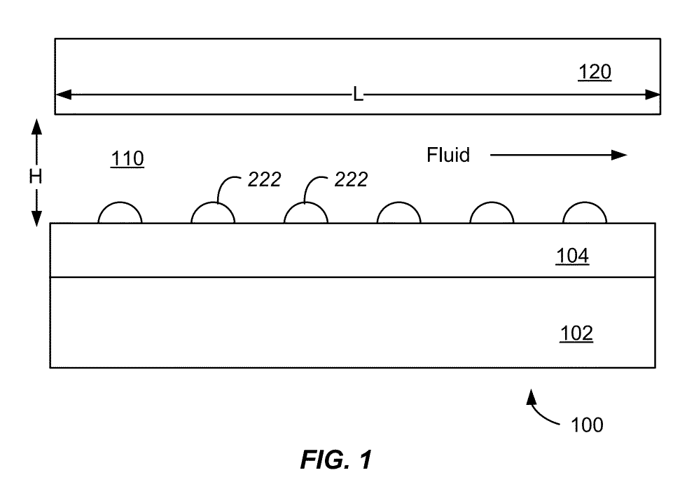

FIG. 1 is simplified schematic diagram illustrating a system for photocatalysis of water according to an embodiment of the present invention. Referring to FIG. 1, a compound substrate 100 is provided. The compound substrate can be fabricating using suitable materials characterized by mechanical rigidity and chemical stability. In some exemplary implementations, the compound substrate includes a support structure 102 and a reaction structure 104. The support structure 102 can be fabricated from quartz, glass, silicon, group III/V materials, silicon on insulator, germanium, combinations thereof, or the like. As illustrated in FIG. 1, the reaction structure 104 can include a metal oxide material that is in the form of a thin film. The reaction structure 104 is laminated to the support structure in the illustrated embodiment although this is not required by embodiments of the present invention. The reaction structure 104 provides support for nanoparticles 222 as described more fully below and interacts with the nanoparticles during the photocatalysis process. Although some embodiments are discussed in terms of photocatalysis of water, the fluid phase can also be a flow of vapor such as water vapor in other embodiments. Moreover, although reaction structure 104 is illustrated as a thin film in FIG. 1, this is not required by embodiments of the present invention and the reaction structure can also be one or more grains of material disposed on a substrate, supported in a solution, or the like. One of ordinary skill in the art would recognize many variations, modifications, and alternatives.

The reaction structure 104 is fabricated using metal oxide materials in some embodiments, for example, ceria. A plurality of nanoparticles or nanostructures 222 are provided on a surface of the reaction structure 104. In the illustrated implementation, a plurality of metallic structures having nanoscale structural features are formed in contact with the reaction structure 104. In some implementations, the nanoparticles can be formed as generally spherical or hemispherical particles and can have a radius from about 0.5 nm to about 500 nm, for example, from about 1 nm to about 100 nm, more particularly, a few tens of nanometers. The particles can be dispersed on the metal oxide in a random or predetermined pattern depending on the particular implementation. The metal nanoparticles with an optical resonance, e.g., gold, are in direct contact with metal oxide in the embodiment illustrated in FIG. 1.

Nanoparticles 222 illustrated in FIG. 1 are depicted as hemispheres simply for illustrative purposes and can be any desired shape as appropriate to the particular application. As examples, the nanoparticles can be gold nanoparticles formed on the surface of ceria. The spacing between the nanoparticles, the density of the nanoparticles on the reaction substrate, and the like depend on the method of manufacture and embodiments of the present invention can utilize a variety of densities and nanoparticle sizes, including a distribution of nanoparticle sizes.

A capping layer 120 is coupled to the composite substrate at locations not shown in FIG. 1. The capping layer 120 can be one of several materials that provide suitable adhesion to the compound substrate and provide for a degree of chemical stability, with PDMS or other silicone-based materials being suitable examples. A fluid (e.g., an aqueous fluid) is supported in the space 110 between the compound substrate 100 and the capping layer 120 and is able to flow through space 110 as illustrated in FIG. 1. It should be appreciated that a channel for fluid flow can be defined using fabrication techniques to provide flow channels of suitable geometry. As an example, a flow channel with a substantially rectangular cross section can be formed, with the height of the flow channel illustrated as H in FIG. 1, the length illustrated by L and the width extending into the plane of the figure and not illustrated for purposes of clarity.

In the embodiment illustrated in FIG. 1, the fluid flowing through the illustrated flow channel is an aqueous solution (i.e., a water-based solution), but other sources of hydrogen including water vapor are included within the scope of the present invention. As illustrated in FIG. 1, fluid flow through a channel can be utilized in the photocatalysis processes described herein. In alternative embodiments, flow of water, water vapor, or other aqueous fluids over coated grains of ceria can be used in place of or to supplement the channel-based flow illustrated in FIG. 1.

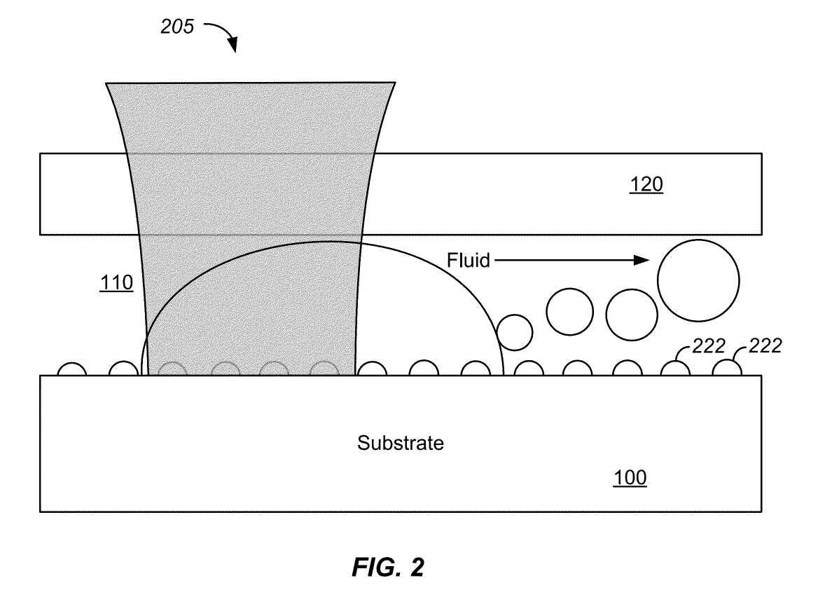

FIG. 2 is a simplified schematic diagram illustrating a photocatalysis process according to an embodiment of the present invention. As illustrated in FIG. 2, electromagnetic radiation 205 is incident on a portion of the system illustrated in FIG. 1. Upon exposure to electromagnetic radiation of an appropriate wavelength or frequency, the nanoparticles 222 support a plasmon resonance (also referred to as a Photon-Electron resonance) in which the electromagnetic energy from the electromagnetic radiation (e.g., a laser) is efficiently converted into a collective electron motion in a solid structure (i.e., the nanoparticles). The plasmon resonance frequency may be derived by solving Maxwell's equations with the appropriate boundary conditions or it can be measured empirically from reflection or absorption spectra.

The nanoparticles have a resonant plasmon absorption to visible light incident on them that is near or contains the resonant frequency of the metal nanoparticles. That is, the Photon-Electron resonance associated with the nanoparticles provides a particular thermal characteristic associated with the nanoparticles, namely, localized heating of the nanoparticles to a selected temperature as a result of the absorption of at least a portion of the electromagnetic radiation having the appropriate frequency. In addition, there is also a very strong local electric field. Thus, the effects provided by embodiments of the present invention can include both thermal and electronic components. Referring once again to FIG. 2, the one or more nanoparticles are irradiated with electromagnetic radiation having a pre-selected frequency, in a predetermined spatial region. The predetermined spatial region can be substantially defined by the overlap between the electromagnetic radiation and the position of the one or more nanoparticles upon the reaction substrate. The predetermined spatial region can also include areas of the reaction substrate upon which the one or more nanoparticles are not disposed. The spatial region can also include areas less than the areas of the reaction substrate upon which the one or more nanoparticles are disposed, e.g. irradiation falls upon some particles but not others at a given time.

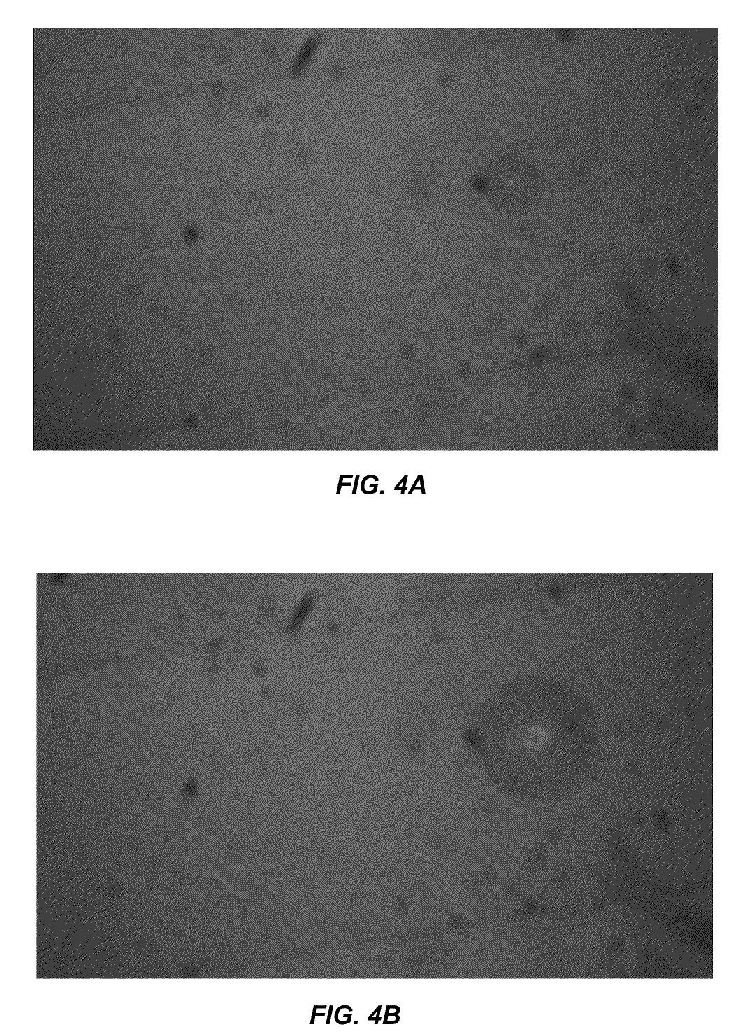

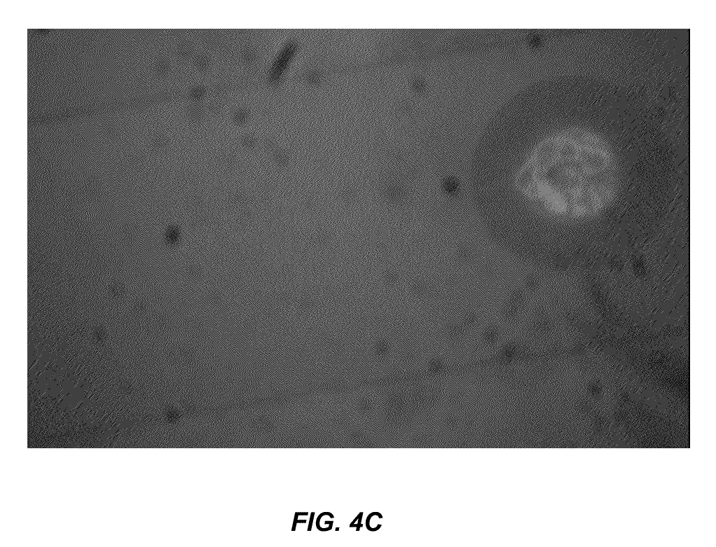

The absorption of the electromagnetic radiation as a result of the plasmon resonance results in an increase in temperature of the one or more nanoparticles having the thermal characteristic to at least a selected temperature. The specific and localized heating provided by the plasmon resonance occurring as a result of the interaction of the electromagnetic radiation with the delocalized surface electrons of the one or more nanoparticles, provides the required energy (i.e. heat) as well as other electrochemical effects to instigate the photocatalysis process and the resulting production of hydrogen gas. Referring to FIG. 2, the nanoparticles adhered to or supported by the reaction substrate are placed into an aqueous electrolyte solution as the solution flows past the nanoparticles. The solution may contain a dissolved electrolyte, e.g.. NaOH or other suitable electrolyte. As described more fully below, chemical reaction ensues as a result of the plasmon resonance interaction that converts hydrogen in the water to hydrogen gas. Gas bubbles captured by the microchannel are illustrated in FIGS. 4B-4D. As discussed herein, embodiments of the present invention are not limited to microchannel-based implementations and other systems suitable for photocatalysis are included within the scope of the present invention.

In a particular embodiment described herein, the metal structure includes a ceria (CeO₂) film disposed on a quartz substrate, although this particular arrangement is not required by the present invention. Gold nanoparticles are physically attached to the ceria film. A micro channel of PDMS is formed as a top layer of the system as illustrated in FIG. 1. An aqueous solution of NaOH flows over the film. A laser of wavelength 532 nm is incident upon the nanoparticles in some embodiments to provide a plasmon resonance with the gold nanoparticles. In other embodiments, other wavelengths of electromagnetic radiation are used, for example, electromagnetic radiation characterized by a wavelength between 200 nm and 20 μm.

Embodiments of the present invention provide methods and systems capable of producing hydrogen from water using visible sunlight as the only energy source, while using a stable earth abundant catalyst. As described below, plasmon mediated photosynthesis is used to photolyze water or other sources of hydrogen into hydrogen (a water splitting reaction) without significant degradation to the catalyst.

As described throughout the present invention, one implementation utilizes a ceria substrate with gold nanoparticles disposed thereon. An incident photon is coupled into a surface plasmon wave at or near the Au/CeO₂ interface. Hydrogen is produced and as described in relation to FIG. 1, some embodiments flow a fluid past the nanoparticles, thereby carrying away the hydrogen or hydrogen containing molecules, and/or oxygen.

Embodiments of the present invention provide benefits not available using conventional processes since the high energy quasi-particle (i.e., the plasmon) provides localized heating resulting in ceria reduction while the overall system remains at a low (e.g., room) temperature. Thus, the plasmon enhanced process described herein provides for localized high temperature processes in a low temperature environment.

According to some embodiments of the present invention, the reaction chemistry is a function of the characteristics of the fluid utilized in the hydrogen production process, for example, the pH of the water surrounding the Au/ceria structures. As an example, the inventor has determined that the use of an NaOH buffer solution promotes hydrogen evolution in some implementations. Other electrolytes that are suitable for use in hydrogen production include KOH or the like.

Additionally, the light intensity incident on the Au/ceria structures can impact the hydrogen production, for example, the efficiency of hydrogen generation can increase with light flux. In some embodiments, the threshold flux level changes with gold nanoparticle size and spacing. In other embodiments, the reaction rate profile as a function of light wavelength is wavelength dependent, which is consistent with the explanation of plasmon mediated photochemistry provided herein.

Although ceria has been used in some exemplary embodiments, the alloy composition of the materials utilized in the chemical reaction can be modified depending on the particular applications. As an example, various dopants can be incorporated into the ceria alloys to enable oxygen storage at lower temperatures. Thus, the hydrogen production efficiency can be improved in some implementations by doping the ceria with select metals in order to improve the oxygen storage capacity or other material properties associated with the photochemistry processes.

Because of the plasmon resonance provided by the nanoparticles, temperature increases are produced locally and the reaction can be limited to the surface where the oxygen vacancies are created.

Without limiting embodiments of the present invention, the inventor believes that a potential mechanism for hydrogen production is the following reactions:

e⁻+2CeO₂→Ce₂O₃+O⁻ (1)

e⁻+O⁻+H₂O→2OH⁻. (2)

The following reaction also occurs:

H₂O+Ce₂O₃→2CeO₂+H₂. (3)

As illustrated in equation (1), an incident photon is coupled into a surface plasmon wave at the nanoparticle/substrate interface (e.g., a Au/CeO₂ interface). The CeO₂ is reduced to cerium trioxide, producing an oxygen vacancy. As illustrated in equation (2), a hydroxyl ion is released as the oxygen vacancy reacts with water in solution. Thus, transfer of charge from the solution into the ceria is provided through the plasmon resonance in addition to a local increase in surface temperature.

Using a gas chromatograph and a quadrupole mass spectrometer, evidence for hydrogen production has been obtained. Additionally, Raman spectroscopy of ceria demonstrates the presence of oxygen vacancies under irradiation. Exposure of the Au/ceria nanoparticle/substrate structure illustrated in FIG. 1 resulted in depletion of the oxygen vacancy signal, whereas, exposure of a dry Au/ceria structure to light resulted in an unaltered signal. Although ceria is used as an exemplary metal oxide in some embodiments, the present invention has wider applicability and can utilize other metal oxides or other materials capable of supporting oxygen vacancies and capable of absorbing water to produce hydrogen. Examples include iron oxide, titanium oxide, YBCO, lead titanate, barium strontium titanate, combinations thereof, or the like. As demonstrated by this list, materials with differing oxygen charge states can be utilized in embodiments of the present invention.

According to embodiments of the present invention, an aqueous solution including an electrolyte is utilized during the hydrogen production process. As examples, sodium hydroxide can be used as an electrolyte to provide free charges in solution. In combination with the electrolyte, the nanoparticle is able to take a charge from solution and transfer it into the metal oxide (e.g., ceria) to reduce the metal oxide.

Some exemplary implementations allow for spatial control of the hydrogen production process on a scale of nanometers. This also provides for a high degree of temporal and/or spatial control of the temperature of the nanoscale particles. As an example, terminating or reducing the flux of the incident electromagnetic radiation flux delivered to the nanometer sized structures results in very rapid lowering of temperature at the nanometer sized structures, i.e. a previously established plasmon resonance of these structures attenuates/diminishes, as does the associated generated localized heat, electron transfer, and other processes.

In some implementations at least one structure is provided upon a substrate in a desired configuration to provide a pre-form, which determines the locality where the at least one nanoparticles are disposed. The pre-form can include a plurality of structures or one structure, where the at least one structure or plurality has, for example, a form selected from the group consisting of a particle, a dot, a sphere, a wire, a line, a film and any combination thereof. In some implementations, the particle, dot, sphere, wire, line, film and any combination thereof have nano-scale dimensions (any one or combination of height, length, width, diameter, radius, diagonal, or the like). In some implementations, the nanoscale particle(s), hemisphere(s), and/or sphere(s) can have a radius from about 0.5 nm to about 500 nm, more particularly, from about 1 nm to 100 nm.

In some exemplary implementations, the at least one structure is or contains at least one metal. The metal can be one of gold, copper, silver, titanium, aluminum, nickel, palladium, platinum, ruthenium, iridium, iron, cobalt, rhodium, osmium, zinc or any combination thereof. The at least one metal can enable electron transfer in conjunction with the metal oxide material

The electromagnetic radiation utilized in some implementations is in the form of a laser beam provided by a laser source. Various laser sources, optical amplifiers, optical frequency conversion devices, and lasers can be utilized in accordance with the present invention. The electromagnetic radiation, for example, can be ultraviolet, visible, or infrared radiation or any combination thereof. In some implementations, the electromagnetic radiation irradiates at least a portion of the substrate, for example, a portion at which hydrogen generation is desired.

According to embodiments of the present invention, the electromagnetic radiation is at or near a photon-electron resonant frequency and collective oscillations or a resonance of the surface electrons is associated with a plasmon resonance. As the size of a structures decreases, there is an increase in the surface-to-volume ratio, which is proportional to 1/R, where R is the radius of the particle. Nanoparticles, in particular, have high surface-to-volume ratios so that there are a larger number of surface electrons relative to bulk electrons. It is generally believed that this accounts for the efficient heating of nanoparticles by electromagnetic radiation at the plasmon resonance frequency. The optimal absorption frequency can depend both on the shape of individual nanoparticles as well as the geometric arrangement of a collection of nanoparticles (e.g., on a surface). Recent experimental evidence suggests that the plasmon resonance phenomenon can occur on very fast time scales. Additional description related to plasmon resonances in nanoparticles is provided in U.S. Pat. No. 7,998,538, entitled “Electrochemical Control of Chemical Catalysis,” the disclosure of which is hereby incorporated by reference in its entirety for all purposes.

According to alternative embodiments, the metal oxide can be provided in a powder form, with the nanoparticles being adhered to the powder. Thus, embodiments of the present invention are not limited to substrate-based approaches. Thus, although the embodiment illustrated in FIG. 2 utilizes nanoparticles deposited on a substrate structure, this is not required by the present invention.

In another embodiment, a metal oxide powder (e.g., ceria powder) is coated or intermixed with metal (e.g., gold) nanoparticles. The mixture was immersed in an aqueous solution inside a vessel, e.g. a micro pipette tube. Upon exposure to electromagnetic radiation, hydrogen production was observed. In an embodiment, the powder can be supported in a matrix, with the aqueous fluid passing through the matrix. In one implementation, a laser of wavelength 532 nm was incident upon the nanoparticles and used to create the plasmon resonance. Hydrogen gas bubbles were generated and captured in the vessel. One of ordinary skill in the art would recognize many variations, modifications, and alternatives.

Although embodiments of the present invention are illustrated in terms of splitting of water to produce hydrogen, embodiments of the present invention are not limited to this particular electrochemical reaction and other electrochemical reactions can be implemented using embodiments of the present invention.

Embodiments of the present invention provide a unique chemical reaction environment in which temperature increases are limited to localized regions, facilitating reactions that would not occur in an environment that is uniformly hot or cold.

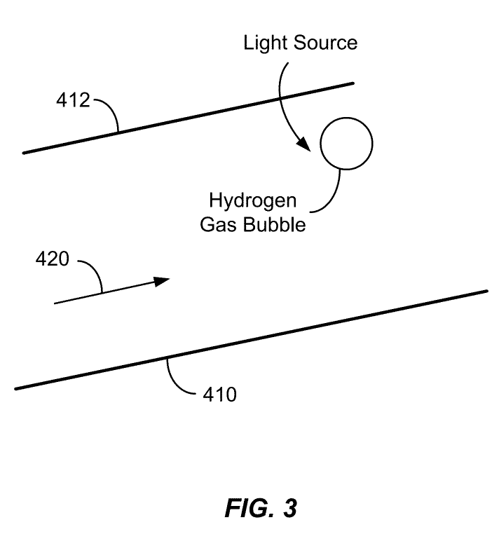

FIG. 3 is a simplified schematic diagram illustrating a microchannel operable to support photocatalysis of water according to an embodiment of the present invention. The microchannel includes sides 410 and 412, which are visible in FIGS. 4A-4C oriented at approximately the angle to the horizontal illustrated in FIG. 3. The view provided in FIG. 3 is a plan view and fluid flows through the microchannel (in the plane of the figure) along direction 420. A portion of the region illustrated in FIG. 3 is irradiated with electromagnetic radiation. Although not visible in FIGS. 4A-4C, a plurality of gold nanoparticles are present on the surface of the ceria substrate forming the bottom section of the microchannel.

FIGS. 4A-4C are images of a hydrogen bubble formation in the microchannel illustrated in FIG. 3 according to an embodiment of the present invention. Referring to FIG. 4A, a small hydrogen bubble is illustrated as a dark circle. The laser spot (i.e., the focused laser light that drives the plasmon resonant absorption) is illustrated as a bright region at the center of the circle. As illustrated in FIG. 4B, the dark circle associated with the growing hydrogen bubble is enlarged with respect to FIG. 4A. The laser spot is illustrated as refracting through the fluid/hydrogen bubble interface, producing a enlarged spot size. As illustrated in FIG. 4C, the hydrogen bubble has continued to grow in size, with multiple refraction and reflection events causing continued spreading of the laser spot.

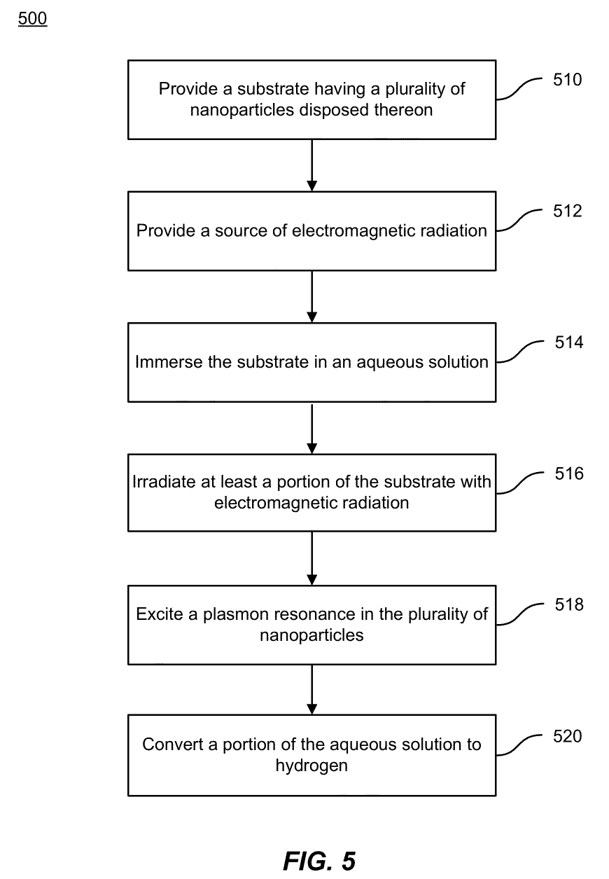

FIG. 5 is a simplified flowchart illustrating a method of producing hydrogen according to an embodiment of the present invention. The method 500 includes providing a substrate having a plurality of nanoparticles disposed thereon (510) and providing a source of electromagnetic radiation (512). As an example, the substrate can include a metal oxide (e.g., ceria) supported on a support material such as glass, quartz, or the like. The plurality of nanoparticles can include metal nanoparticles such as gold nanoparticles. The source of electromagnetic radiation can include one or more lasers, one or more LEDs, a lamp, or other suitable light source.

The method also includes immersing the plurality of nanoparticles in an aqueous solution (514) and irradiating at least a portion of the substrate having the plurality of nanoparticles disposed thereon with electromagnetic radiation (516). A plasmon resonance is excited in the plurality of nanoparticles as a result of absorption of a portion of the electromagnetic radiation (518) and a portion of the aqueous solution is converted to hydrogen (520). In some implementations, the aqueous solution flows through a microchannel or other suitable structure to bring the solution in contact with the substrate and/or the plurality of nanoparticles as illustrated in FIGS. 4A-4D. Although embodiments of the present invention are discussed in relation to use of an aqueous solution, water vapor and gases containing water vapor can be utilized in alternative embodiments.

It should be appreciated that the specific steps illustrated in FIG. 5 provide a particular method of producing hydrogen according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

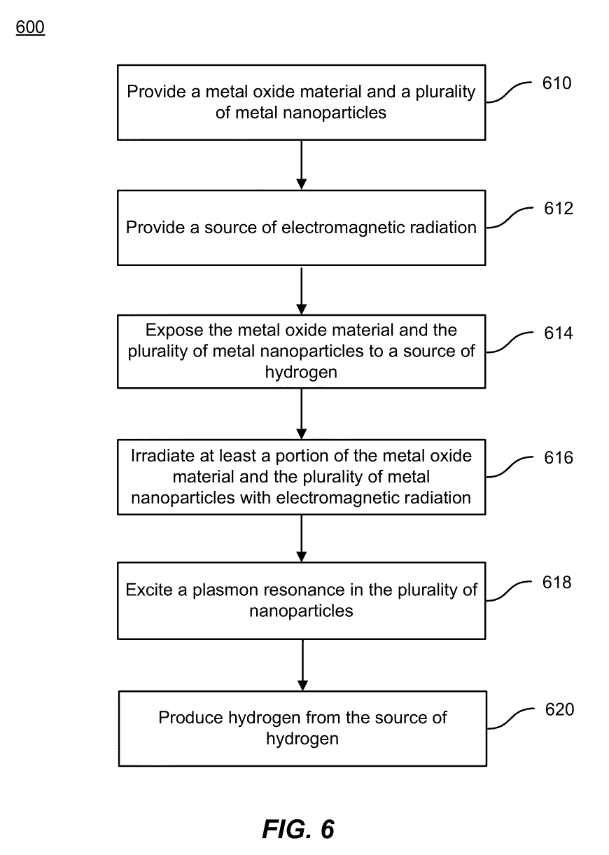

FIG. 6 is a simplified flowchart illustrating a method of producing hydrogen according to an embodiment of the present invention. The method 600 includes providing a metal oxide material and a plurality of metal nanoparticles (610). The metal nanoparticles (e.g., gold nanoparticles) may be coupled to the metal oxide material, such as nanoparticles disposed on a substrate including metal oxides (e.g., ceria disposed on a substrate such as glass or quartz), nanoparticles adhered to metal oxide powders, for example, ceria in powder form, or the like. The nanoparticles can be deposited on the ceria and can be fabricated using a variety of materials including metals and metal alloys, such as gold or other metals.

The method also includes providing a source of electromagnetic radiation (612), such as a laser or one or more LEDs. The method further includes exposing the metal oxide material and the plurality of metal nanoparticles to a source of hydrogen (614). The source of hydrogen can be an aqueous solution in fluid communication with the metal oxide material and the plurality of metal nanoparticles. The aqueous solution includes an electrolyte in some embodiments. The source of hydrogen can also be water vapor.

The method further includes irradiating at least a portion of the metal oxide material and the plurality of metal nanoparticles with the electromagnetic radiation (616). Irradiation of the structure results in excitation of a plasmon resonance in the plurality of metal nanoparticles (618) and production of hydrogen from the source of hydrogen (620). One of ordinary skill in the art would recognize many variations, modifications, and alternatives.

It should be appreciated that the specific steps illustrated in FIG. 6 provide a particular method of producing hydrogen according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

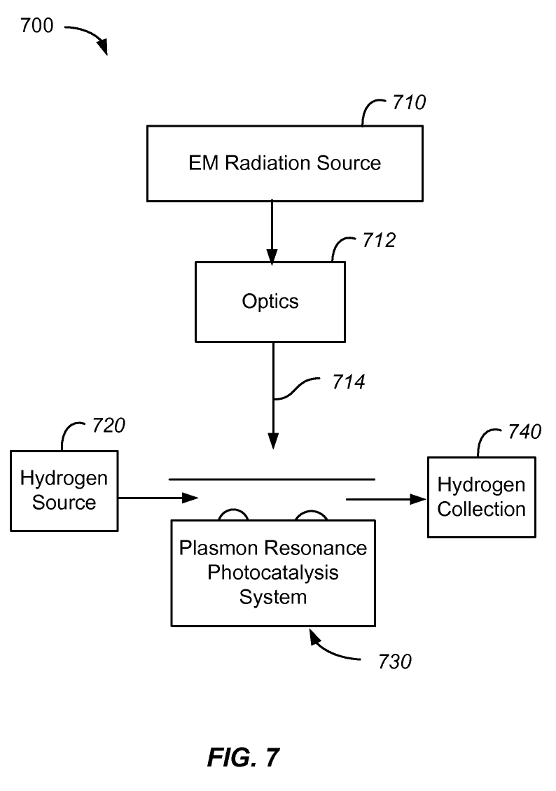

FIG. 7 is a simplified schematic diagram of a system for producing hydrogen according to an embodiment of the present invention. The system includes a source of electromagnetic radiation 710, for example, a laser, an LED, or other suitable light source. The system also includes optics 712 operable to direct the electromagnetic radiation from the source to the plasmon resonance photocatalysis system 730. In some implementations, the optics 712, which can also be referred to as an optical system, are integrated into the source of electromagnetic radiation 710.

In the embodiment illustrated in FIG. 7, the plasmon resonance photocatalysis system 730, which can also be referred to as a for use in hydrogen production includes a substrate having a plurality of nanoparticles disposed on the substrate. As an example, the substrate could include a metal oxide material, such as ceria and the nanoparticles could include metal nanoparticles such as gold nanoparticles. In some embodiments, the nanoparticles comprise metal nanoparticles having a dimension of about 0.5 nm to about 500 nm, although these particular sizes are not required by embodiments of the present invention.

A source of hydrogen is provided by hydrogen source 720 (e.g., an aqueous source providing an aqueous fluid) and is directed so that it is in fluid communication with the plasmon resonance photocatalysis system, for example, the substrate and the plurality of nanoparticles disposed on the substrate. When the structure is illuminated, photons are absorbed as part of the plasmon resonance process supported by the nanoparticles and the substrate. Thus, a plasmon absorption region is formed and is able to absorb electrons from the solution. Additionally, a reaction region of the substrate is formed at which hydrogen is produced as a result of the catalysis process. To facilitate electron transfer, an electrolyte is typically dissolved in the aqueous solution. In some embodiments, a microfluidic channel can be used to contain the aqueous solution that is in fluid communication with the substrate and the plurality of nanoparticles. In other embodiments, the nanoparticles are disposed, not on a substrate, but on a powder material, which can be immersed in the aqueous solution. One of ordinary skill in the art would recognize many variations, modifications, and alternatives.

The hydrogen produced by the system is collected in hydrogen collection unit 740. In some embodiments, oxygen is also produced and can be collected in addition to the hydrogen. The hydrogen source material exiting the plasmon resonance photocatalysis system 730 can be recycled using fluidic components (not shown) and reintroduced into the system as illustrated by the solution flowing from the hydrogen source. Although embodiments are illustrated in terms of a system utilizing a substrate on which the metal oxide materials and metal nanoparticles are disposed, embodiments of the present invention are not limited to this implementation and metal oxide powders, for example, supported in solution, can be utilized as well. One of ordinary skill in the art would recognize many variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims

What is claimed is:

1. A method of producing hydrogen, the method comprising:
providing a substrate having a plurality of nanoparticles disposed thereon;
providing a source of electromagnetic radiation;
immersing the plurality of nanoparticles in an aqueous solution;
irradiating at least a portion of the substrate having the plurality of nanoparticles disposed thereon with electromagnetic radiation;
exciting a plasmon resonance in the plurality of nanoparticles; and
converting a portion of the aqueous solution to hydrogen.

2. The method of claim 1 wherein the substrate comprises a metal oxide.

3. The method of claim 2 where the metal oxide comprises ceria.

4. The method of claim 1 wherein the plurality of nanoparticles comprise metal nanoparticles.

5. The method of claim 4 wherein the metal comprises gold.

6. The method of claim 1 wherein the substrate further comprises at least one of glass or quartz.

7. The method of claim 1 wherein immersing the plurality of nanoparticles comprises flowing the aqueous solution in a microchannel adjacent to the plurality of nanoparticles.

8. The method of claim 1 wherein the source of electromagnetic radiation comprises a laser.

9. The method of claim 1 wherein the electromagnetic radiation is characterized by a wavelength between 200 nm and 20 μm.

10. A method of producing hydrogen, the method comprising:
providing a metal oxide material and a plurality of metal nanoparticles;
providing a source of electromagnetic radiation;
exposing the metal oxide material and the plurality of metal nanoparticles to a source of hydrogen;
irradiating at least a portion of the metal oxide material and the plurality of metal nanoparticles with the electromagnetic radiation;
exciting a plasmon resonance in the plurality of metal nanoparticles; and
producing hydrogen from the source of hydrogen.

11. The method of claim 10 wherein the plurality of metal nanoparticles are coupled to the metal oxide material.

12. The method of claim 10 wherein the source of hydrogen comprises an aqueous solution in fluid communication with the metal oxide material and the plurality of metal nanoparticles.

13. The method of claim 12 wherein the aqueous solution comprises an electrolyte.

14. The method of claim 10 wherein the source of hydrogen comprises water vapor.

15. The method of claim 10 wherein the metal oxide material comprises ceria disposed on a substrate.

16. The method of claim 10 wherein the metal oxide material comprises ceria in powder form.

17. The method of claim 10 wherein the metal nanoparticles comprise gold nanoparticles.

18. A structure for use in hydrogen production, the structure comprising:
a substrate having a plurality of nanoparticles disposed thereon;
an aqueous solution in fluid communication with the substrate;
a source of electromagnetic radiation;
an optical system directing the electromagnetic radiation to impinge on the substrate;
a plasmon absorption region of the substrate operable to absorb electrons from the solution; and
a reaction region of the substrate operable to produce hydrogen.

19. The structure of claim 18 wherein the nanoparticles comprise metal nanoparticles having a dimension of about 0.5 nm to about 500 nm.

20. The structure of claim 19 wherein the metal nanoparticles comprise gold.

21. The structure of claim 18 wherein the substrate comprises a metal oxide.

22. The structure of claim 21 wherein the metal oxide comprises ceria.

23. The structure of claim 18 wherein the aqueous solution comprises an electrolyte.

24. The structure of claim 18 further comprising a microfluidic channel containing the aqueous solution in fluid communication with the substrate.
